(19) United States
(12) Patent Application Publication
(10) Pub. No.: US 2015/0246283 A1
(43) Pub. Date: Sep. 3, 2015

(54) SERVER BASED MOBILE GAME VIEWING LOGIC

(71) Applicant: AMI Entertainment Network, LLC, Trevose, PA (US)

(72) Inventors: Augustus John RUSSO, Blue Bell, PA (US); Michael G. MAAS, New Hope, PA (US); Matt BRENNER, Philadelphia, PA (US); Austin MARTIN, Bensalem, PA (US)

(21) Appl. No.: 14/636,721

(22) Filed: Mar. 3, 2015

Related U.S. Application Data
(60) Provisional application No. 61/946,976, filed on Mar. 3, 2014.

(51) Int. Cl. A63F 13/35; A63F 13/86

(52) U.S. Cl. CPC A63F 13/35; A63F 13/86

(57) ABSTRACT

A system and associated methods are provided for displaying aspects of one or more multiplayer games on one or more venue display devices. Players may interact with the games via mobile devices and may be organized into virtual tables, fields, tracks, or other groupings. The system, based on a determination of which players are physically located at the venue with a particular display device, may select views of games comprising information or views related to those local players.

### CROSS-REFERENCE TO RELATED APPLICATIONS

This application claims the benefit of U.S. Provisional Patent Application No. 61/946,976, filed on Mar. 3, 2014, entitled “Server Based Mobile Game Viewing Logic,” the entire contents of which are incorporated herein by reference in their entirety.

### BACKGROUND OF THE INVENTION

Venues such as bars, restaurants, and casinos, often supplement their services by providing multimedia content for the enjoyment of patrons. Outputting content that is relevant to patrons of a venue may encourage patrons to remain at the venue for longer periods of time, thereby allowing the venue to increase per-patron revenue. Furthermore, presenting desirable content may attract new and repeat patrons to a venue.

Such content is typically output on display devices deployed at the venues, such as televisions, projectors, or computer monitors. Typically a content output device, such as a computer, set-top box, disc player, or media-streaming device, is communicatively coupled to the display device. The content output device receives and/or reads the content from a medium or network such as the Internet, a cable television network, a satellite, or an optical or mass storage medium.

Another method for increasing engagement in a venue is to provide games, particularly multiplayer games. Dedicated gaming machines, however, require space and capital investment. Furthermore, even if gaming machines are purchased, the limited number of available machines generally limits engagement.

As mobile devices, such as cellular phones, have increased in capability, they have become viable platforms for gaming. Each patron will generally be carrying at least one mobile device. Mobile device games, however, do not provide any engagement with the venue that may increase patron participation and revenue.

It would therefore be desirable to provide systems and methods to increase patron engagement in gaming at a venue that are not limited by the number of dedicated gaming systems at the venue, particularly by leveraging mobile devices.

### SUMMARY OF THE INVENTION

Embodiments of the present invention relate generally to providing real-time display of aspects of multiplayer games via electronic devices connected to publicly viewable screens deployed at venues. A system and associated methods are provided for displaying aspects of one or more multiplayer games on one or more venue display devices. Players may interact with the games via mobile devices and may be organized into virtual tables, fields, tracks, or other groupings. The system, based on a determination of which players are physically located at the venue with a particular display device, may select views of games comprising information or views related to those local players.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a system diagram of a multi-venue gaming and display system 100 having a plurality of venues with deployed content output devices according to a preferred embodiment of the present invention;

FIG. 2 is a sequence diagram of a process of the system of FIG. 1 for venue and game selection using a mobile device application;

FIG. 3 is an illustration of a virtual poker game using the system of FIG. 1;

FIG. 4 is an illustration of the physical devices at a venue in the example game of FIG. 3;

FIG. 5 is a flowchart of an exemplary embodiment of a process of the system of FIG. 1 for adding and removing virtual tables from spotlighting at a venue;

FIG. 6 is a flowchart of an exemplary embodiment of a process of the system of FIG. 1 for determining content for display on a content output device at a venue;

FIG. 7 is a flowchart of an exemplary process of the system of FIG. 1 for assigning a new player to a virtual table; and

FIG. 8 is an illustration of a multiplayer photo comparison game.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates to providing real-time display of aspects of multiplayer games via electronic devices connected to publicly viewable screens deployed at venues.

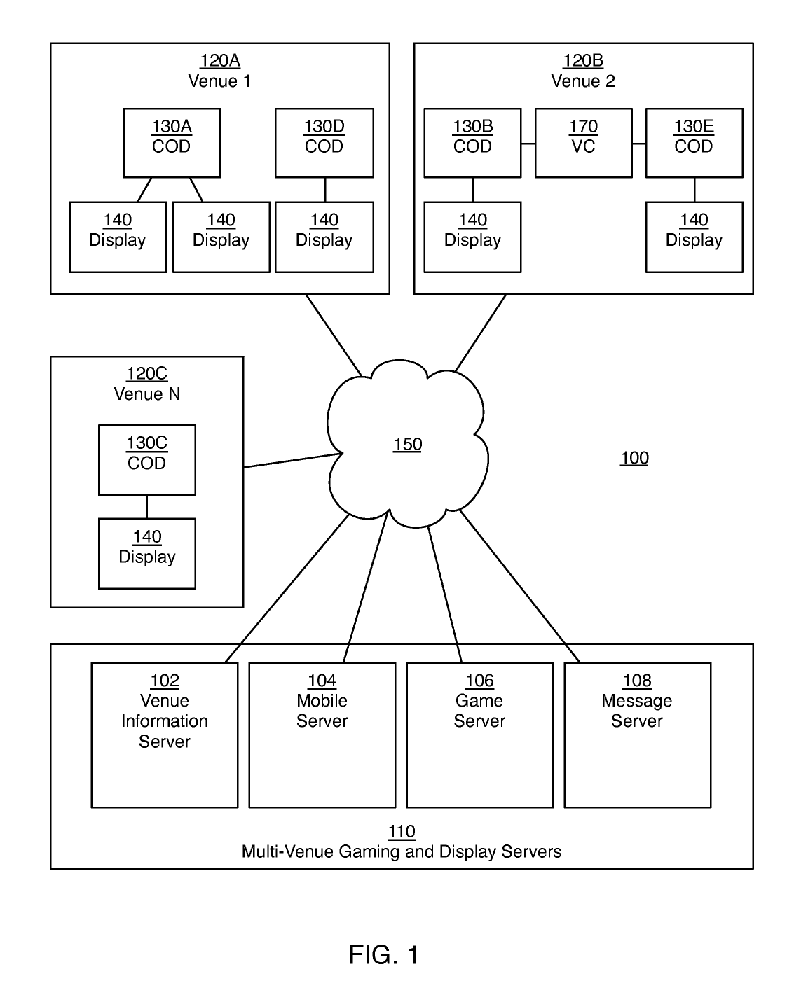

Referring to the drawings in detail, wherein like reference numerals indicate like elements throughout, FIG. 1 is a system diagram of a multiplayer gaming and display system 100 according to a preferred embodiment of the present invention. Servers 110 are connected by a network 150 to content output devices (CODs) 130A, 130B, 130C, and 130D, deployed at a plurality of venues 120A, 120B, 120C. The network 150 is preferably a wide area network, such as the Internet.

Servers 110 may be provided in a variety of configurations. For purposes of discussion, functions are described with respect to separate servers for particular functions. However, it is to be understood that these functions may be combined or separated as needed for a particular implementation within the scope of the invention. In a preferred embodiment, one or more venue information servers 102 may receive, store, and provide information regarding locations of mobile devices and content output devices 130. One or more mobile servers 104 may provide various services to mobile devices connecting to the multi-venue gaming and display system 100. One or more game servers 106 may provide functions related to one or more multiplayer games. For instance, one game server 106 may be allocated for operation of poker games while another may operate trivia games. One or more messaging servers 108 may provide message translation and/or load balancing functions.

The venue information servers 102, mobile servers 104, game servers 106, and message servers 108 may be implemented by any combination of computing devices, including one or more physical or virtual servers. The servers preferably implement an N-tier server infrastructure having one or more application servers, one or more web servers, one or more database server, etc. The servers may connect to each other through a local area network, not shown, or, in some cases, via network 150. The servers 110, as well as the CODs 130, may be implemented using purpose-built or general purpose computing hardware comprising processors for execution of program code for performing the processes described below, memory for storing program code and data, and interfaces for communications. Furthermore, any of the servers may utilize separate database servers for storage and retrieval of data, as well as other specialized servers or devices for other functions.

Each venue 120 preferably has a plurality of CODs 130 that output content to one or more communicatively coupled display devices 140. Each COD 130 may be any device capable of receiving and/or reading multimedia content, and outputting the multimedia content to a display device 140. For example, the CODs 130 may be digital receivers, computer devices, multimedia streaming devices such as APPLETV and BOXEE BOX, cable television set-top boxes, satellite television receivers, TIVO, SLINGBOX, and the like. In a preferred embodiment, each COD 130 is a small computer running a variant of the Linux operating system and additional software. The display devices 140 may be any electronic devices capable of outputting multimedia content to one or more patrons of the venue, such as televisions, projectors, monitors, and the like. In the preferred embodiment, there is no limit to the number of CODs 130 and display devices 140 that may be deployed at any particular venue. Furthermore, each COD 130 may output to more than one display device 140. In some embodiments, a COD 130 and display 140 may be combined in a single unit.

In the exemplary embodiment of FIG. 1, the first venue 120A includes two CODs 130A and 130D. The first COD 130A is connected to two different display devices 140. The second COD 130D is connected to only a single display device 140. In the same example, the second venue 120B includes two CODs 130B and 130E, each connected to a single display device 140. A plurality of other venues 120C also include various combinations of CODs 130 and display devices 140.

If there are multiple CODs at one address, they will preferably display the same content. In the event that the CODs at a particular venue are running different versions of software, associations will preferably be made such that the player connects with games on a server with which the COD with the newer version of software is communicating. In some embodiments, subsets of CODs in a venue may be used to allow display of views of multiple games at a time, or display of advertising simultaneously with one or more games.

CODs 130A, 130B, 130C, and 130D, are registered with the venue information server 102. The venue information server 102 may receive a registration request associated with a COD. The registration request may be a manual request to create a record for a new venue 120, or a dynamic request, such as a request transmitted by a newly-deployed venue controller 170 or COD 130. The request preferably includes information identifying the name and geographic location of the venue, and any other information necessary to register the venue, such as login and password information. The venue information server system 102 creates and/or updates database entries associated with the venue in a venue information database.

Registration of the CODs may be performed in a variety of ways. In one embodiment, a unique identifier of the COD may be associated with an address at which the COD is being installed. In a preferred embodiment, a serial number and MAC address are visible on the exterior of the COD. When a venue receives the COD, the installer may contact technical support by telephonic or electronic means and provide the serial number and MAC address for use in registration of the COD, along with a physical address and other identifying information regarding the venue. Registered addresses may then be provided to mobile device applications, as described below, facilitating, among other functions, association of a patron's mobile device with a venue.

At least some of the venues, such as 120B, may also have a venue controller 170 that is communicatively coupled to each of the CODs 130 deployed at the venue 120 by a local network, not shown. The venue controller 170 preferably provides a centralized graphical user interface, not shown, for controlling the plurality of CODs 130 deployed at the venue. The venue controller 170 may allow venue personnel to change the content output settings (e.g., channel change, volume change, audio source change, and the like) for one or more CODs 130 deployed at the venue 120. In one preferred embodiment, the venue controller 170 is the TAP.tv controller from AMI ENTERTAINMENT NETWORK.

The venue controller 170 may serve as the intermediary between the CODs 130 deployed at the venue 120 and the venue information server system 102 by aggregating data from the CODs 130 deployed at the venue 120 over a local network, not shown. The venue controller 170 may transmit the aggregated data over the network 150 to the venue information server system 102. It should be understood that not all venues 120 must have a venue controller 170. CODs 130 deployed at venues 120 that do not have a deployed venue controller 170 may individually communicate with servers 110 over the network 150.

The venue information server system 102 preferably includes a venue information database storing entries for each of a plurality of registered venues 120. The venue information database may store information identifying the CODs 130 deployed at each of the registered venues 120, for example, by a serial number, MAC address, or the like. Optionally, the venue information database also stores information identifying the display devices 140 deployed at each of the registered venues 120.

Mobile App Launch and Connect

Interaction between players and multiplayer games is preferably facilitated by a mobile device application. The mobile device application may comprise, for instance, program code and data to facilitate connection to game servers, acceptance of game input, and rendering of game state, for a variety of games. In preferred embodiments, the mobile device applications are applications for the Apple iOS or Google Android operating systems and are made available for free download or purchase to users of those systems.

In some embodiments, upon launch, the mobile device application may first consult a specified URL or other identified location for information regarding an address of a mobile server 104 or other server of servers 110 to be contacted. The application may then make a services request to the specified server. The services request will preferably be accompanied by an authentication token known only to authorized mobile device applications. In some embodiments, the application may also be directed to a specific messaging server 108.

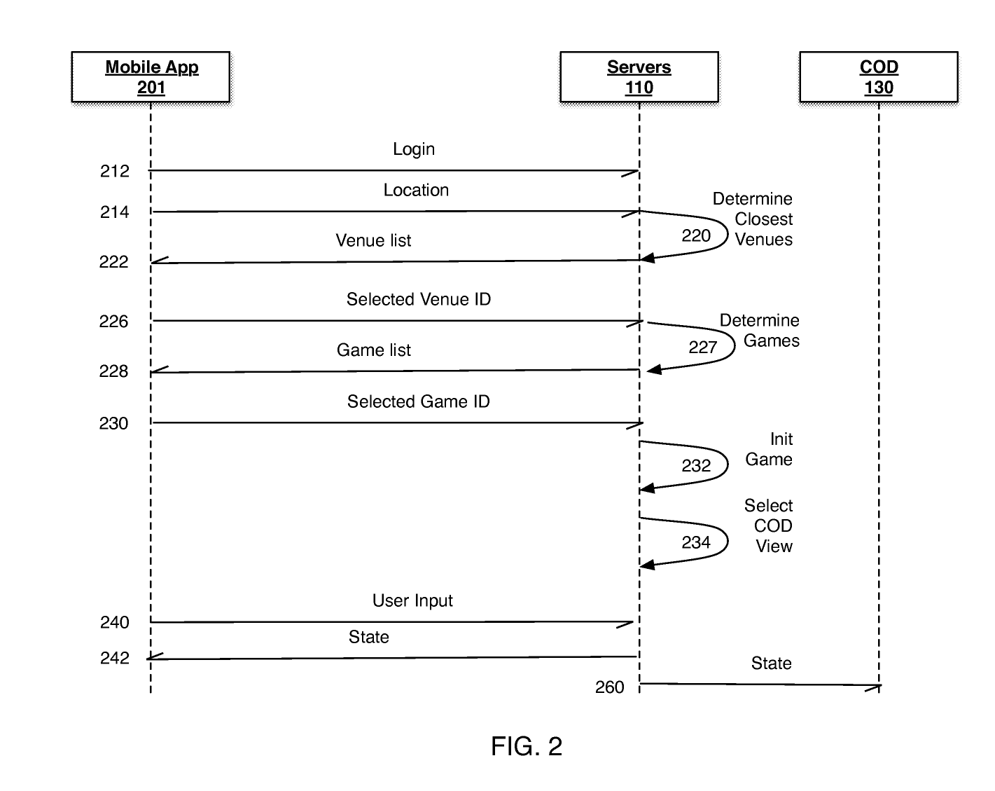

FIG. 2 is a sequence diagram of a process of the system of FIG. 1 for venue and game selection using a mobile device application. The present example assumes that the mobile device application has, or has already obtained, an address for a server associated with the system 100. In some embodiments, the mobile application will connect at launch to an external website, not shown, always available to request the addresses of a mobile server 104 and messaging server 108 to be used. A successful request will preferably require use of a token, which may be hardcoded in the binary of the mobile device application.

At 212, the mobile device application 201 performs a login process with one or more servers of servers 110. In a preferred embodiment, a username and password are used in the login process. The user name and password may be entered by the user or submitted from previously stored information by the application 201. The login process may involve additional steps, not shown, including multiple rounds of communication back and forth between the mobile device application and one or more servers. In a preferred embodiment, communication between the mobile device application and the server is encrypted, preferably using HTTPS.

Upon successful login, the mobile device application 201 preferably obtains location information from the mobile device operating system, if allowed. If location information is not available to the mobile device application, the user may be prompted by the mobile device application to make changes to mobile device settings to allow such access.

Once information regarding the location of the device has been obtained, a registration message 214 is sent to a server 110 associated with the multiplayer gaming system 100. In a preferred embodiment, latitude and longitude data are sent to the server. The server may then determine at 220 which venues are closest to the mobile device location, or within a particular radius, such as 30 miles.

Data regarding nearest venues, or alternatively, regarding the CODs 130 at the venues, is then returned to the mobile app at 222. The data preferably comprises names, locations, and identifiers of the venues. In a preferred embodiment, those venues are then presented by mobile device application 201 to the user in order of distance, from closest to furthest. In a preferred embodiment, the mobile device application 201 sends an HTTP GET to the mobile server 104 with an ID, and receives a JSON object with list of CODs and a list of channels or games.

The user may then select the actual venue at which he or she is present from the presented list. At 226, the mobile device application 201 sends an indication of the selected venue, preferably an ID, back to server 110.

In another embodiment, the accuracy of the location data provided in the registration message may be deemed accurate enough, or the spacing of venues may be large enough, to facilitate automatic selection of the venue in which the device appears to be located. In such a case, the venue appearing to be at the smallest distance from the mobile device may be automatically selected without the return of a list at 222 or response with a selection at 226.

Once a venue has been selected at 226, the server 110, at 227, determines a list of available games associated with the selected venue and sends the mobile device application a list of available games, such as trivia, poker, racing, etc. at 228. The player selects one of the games, causing the mobile device application to contact the server for that game at 230. It is to be understood that while “games” are described for purposes of discussion, the list may comprise other applications with social interaction.

At 232, the game is initialized or the player is joined with an already in-progress game. As will be further described below, if the player is the first player at the venue to join a game or a particular virtual table, the server may then select a new view to be presented on a COD 130 at the player's location at 234.

Following initiation of the user's participation in the game, generally, user inputs will be sent to the servers 110 at 240 and game state information will be sent to the mobile device application 201 at 242 and to the COD 130 at 260, if the COD 130 is displaying aspects of the relevant game. As will be understood by those skilled in the art, 240, 242, and 260 may occur repeatedly and in any order during the progress of a game.

As described above, while reference is made to a game server, the actual implementation may use one or more physical or virtual servers along with load balancers, database servers, routers and other equipment. The term “game server” as used herein refers to the collective function of these components. In a preferred embodiment, each type of game is implemented using a separate game server or cluster.

An exemplary game for use with the present system 100 is poker. In poker, players are arranged in tables. However, given that poker is a multiplayer game and the players may be geographically dispersed, only action related to certain tables may be relevant to patrons at a particular venue.

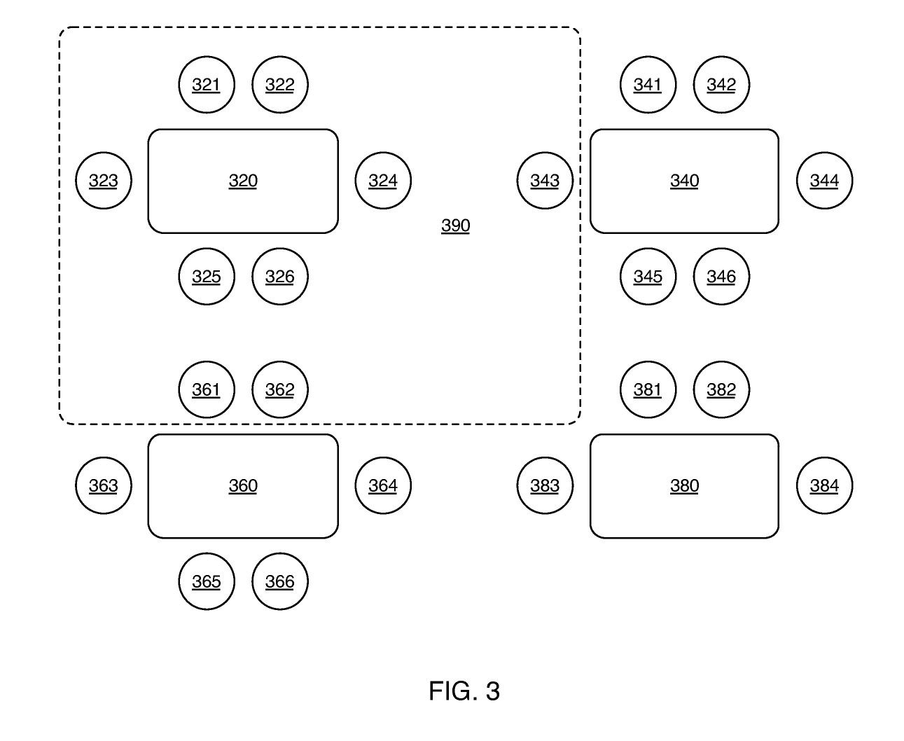

FIG. 3 is an illustration of a virtual poker game using the system of FIG. 1. It is to be understood that the figure merely illustrates one example of a situation in which the invention may be used and that different games or similar games with different numbers of tables or players may similarly be covered. The term “virtual tables” is used for discussion of a poker implementation, but should be considered to refer to any grouping of players such as at a virtual board, track, field, or other playing area.

The virtual poker game of the present example is arranged around virtual tables 320, 340, 360, and 380. Players 321, 322, 323, 324, 325, and 326 are associated with virtual table 320. Players 341, 342, 343, 344, 345, and 346 are associated with virtual table 340. Players 361, 362, 363, 364, 365, and 366 are associated with virtual table 360. Players 381, 382, 383, and 384 are associated with virtual table 380.

Players 321, 322, 323, 324, 325, 326, 343, 361, and 362 represent human players at a single venue 390. Thus, in this example, all of the players at virtual table 320 are at the venue 390, and subsets of the players at table 340 and 360 are at the venue. None of the players at virtual table 380 are at the venue 390, possibly being at one or more different venues or being virtual players. It is to be understood that the diagram refers to virtual grouping and not necessarily to physical grouping at the venue.

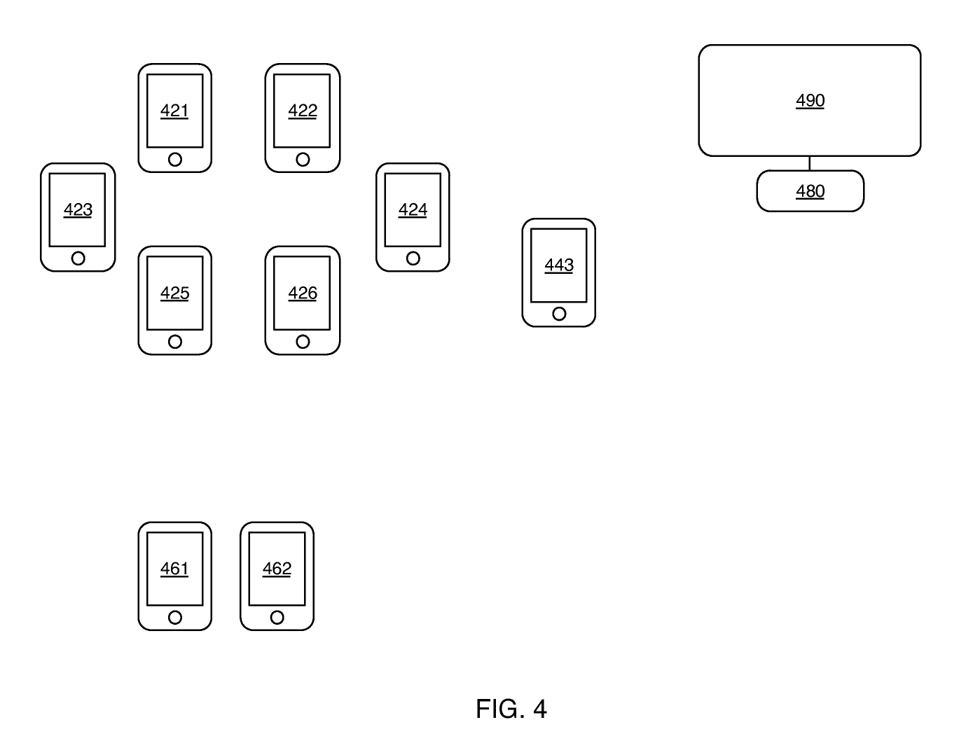

FIG. 4 is an illustration of the physical devices at a venue in the example game of FIG. 3. Mobile devices 421, 422, 423, 424, 425, 426, 443, 461, and 462 represent devices of human players present at venue 390. COD 480 is connected to display 490 at venue 390. Each mobile device 421, 422, 423, 424, 425, 426, 443, 461, and 462 will be in communication with the servers 110.

In a preferred embodiment, while players from venue 390 are playing at virtual tables 320, 340, and 360, information or displays related to those three tables is in rotation on COD 480 and display 490 at that venue. As players at venue 390 are eliminated from the game, however, there may be no remaining players at the venue associated with particular virtual tables. The server detects this and removes those virtual tables from the display rotation on COD 480. For instance, if player 443 stops playing, no player physically at venue 390 remains at virtual table 340, making the action at virtual table 340 no longer relevant to patrons of venue 390. Thus, table 340 is dropped from the display rotation.

In certain types of games, particularly card games, portions of each player's hand are shown and portions are hidden. The system 100 is preferably designed such that hidden cards are shown only to the holder of that hand on that player's mobile device via the mobile device application. Content output device 480 will only show cards that should be visible to other players. For instance, if a preferred embodiment of the present system 100 is applied to a virtual game of Texas Hold 'Em, community cards may be displayed on the display 490, while hole cards are only shown on each individual player's mobile device.

In a preferred embodiment, when a particular virtual table is spotlighted on the display, players associated with that virtual table at one or more venues will need to look at the display at their venue to view the community cards. The display, however, may also occasionally display advertising content during ad breaks. During each ad break, community cards may preferably be displayed by the mobile device application to allow continuation of play while the community cards are not visible on the displays. In a preferred embodiment, an ad break is approximately two minutes long. For certain types of games, such as racing games, ad breaks may be preferably scheduled between the conclusion of one race and the beginning of another.

In some embodiments, for those tables that are in the display rotation, the system 100 may further focus on individual players at the virtual table.

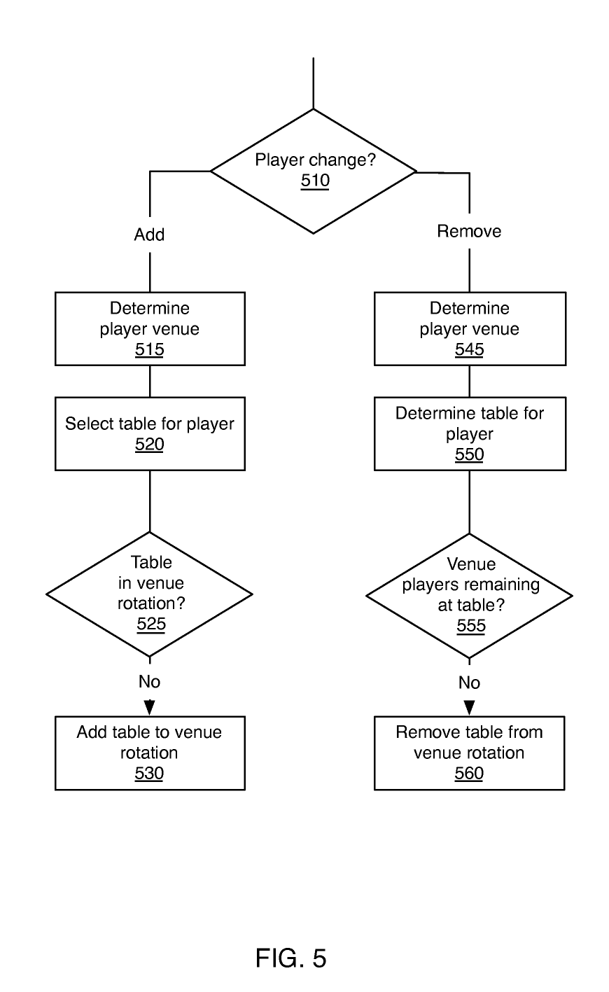

FIG. 5 is a flowchart of an exemplary embodiment of a process of the system of FIG. 1 for adding and removing virtual tables from spotlighting at a venue. It is to be understood that the steps of the process do not necessarily need to be performed in the order shown or described.

At 510, a player change is detected. If a player is being added to a table, the venue for that player is determined at 515. As described earlier, the mapping of players to venues may be stored in a server database, with each entry preferably established upon connection of the mobile device application to the server.

At 520, a virtual table is selected for the player. A player is preferably assigned to a virtual table already associated with players at the same physical venue. At 525, a determination is made as to whether the selected virtual table for the new player is already in the spotlighting rotation for the player's venue. If the table is not yet in the rotation, the virtual table is added to the spotlighting rotation for that venue at 530.

If it is determined at 510 that a player has left a game, a determination is then made at 545 of the player's physical venue. At 550 the virtual table associated with the departing player is determined. At 555, a determination is made as to whether other players at the departing player's venue remain at the departing player's virtual table. If not, the table is removed from the spotlighting rotation for that venue at 560. It is to be understood that determination of venue and virtual table may be made in any order and may already have been determined at a previous point in time.

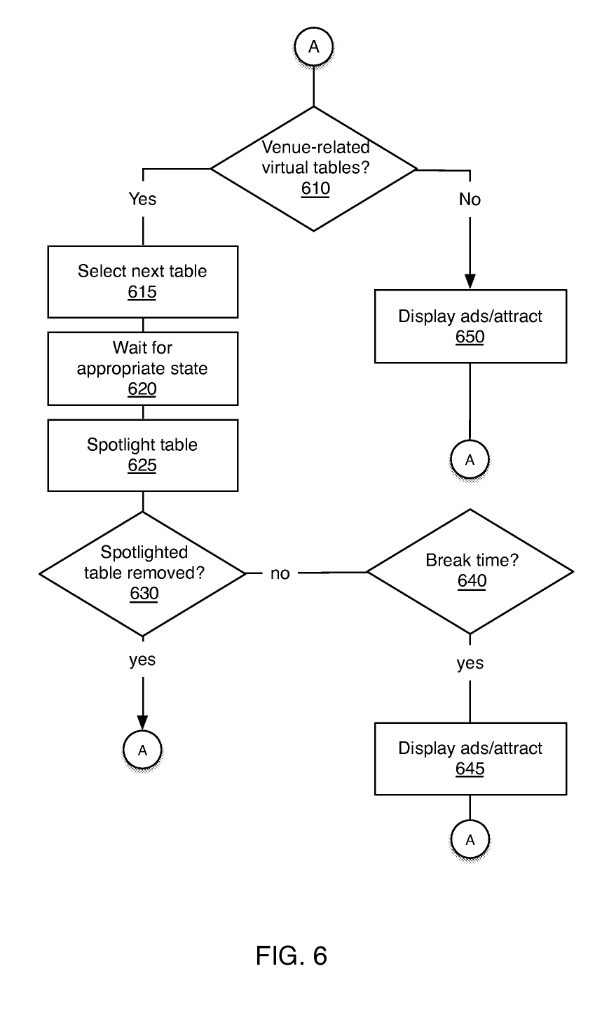

FIG. 6 is a flowchart of an exemplary embodiment of a process of the system of FIG. 1 for determining content for display on a content output device at a venue. The process relates generally to selection, at a server, of content to be displayed for a particular COD or venue. As described above, while determinations may be described as being made with respect to a venue, single venues may have multiple CODs, which may, in some embodiments, be treated essentially as separate virtual venues or provide the capability of simultaneous display of multiple types of content in the same venue.

At 610, a determination is made as to whether any virtual tables are associated with players at the venue of interest. In some embodiments, this determination may span multiple types of games. For instance, the server may first determine whether any player at the venue is associated with a virtual poker table. If not, the server may then determine whether any players at the venue are associated with a virtual racing track or other game grouping, or associated with a trivia game. For discussion purposes, these associations will be described generally as association with a virtual table.

If there are virtual tables associated with players at the venue, the next table for display is selected at 615. In the event that players at a venue are only associated with a single virtual table, that table will be selected. In the event of association of players at the venue with multiple virtual tables, the system 100 will preferably rotate through those virtual tables in round-robin fashion.

At 620, the system 100 waits for the virtual table selected at 615 to reach an appropriate point for initiation of spotlighting. In the case of a card game, the system 100 may wait for the beginning of a deal of a hand. For a racing game, the system 100 may wait for the beginning of a race. While waiting, the system 100 may display advertising content or a message indication that game content will appear soon. In some embodiments, the system 100 may direct the COD 130 to immediately begin display of content related to the virtual table without waiting at 620.

At 625, once an appropriate point has been reached for initiation of spotlighting, the content output device or devices at the venue will be directed to display a view of the selected virtual table. As described above, spotlighting may preferably be implemented by executing program code on the content output device that is largely similar to the game program code executing on the mobile devices. In the case of the content output device, however, in response to receiving game state information, a view of the game relevant to all players at the virtual table will preferably rendered, rather than a view relevant primarily to a single player.

The system 100 may continually check, or be responsive to an indication, at 630, that the virtual table being spotlighted has been removed from the list of tables to be spotlighted for the venue. This may occur, for instance, at 560, above. If the virtual table being spotlighted is removed, the process preferably returns to 610 for selection of new content. If the virtual table is not removed during spotlighting, the system 100 may also make a determination as to whether it is time for an advertising break at 640. If the time has been reached for an advertising break, ads will be displayed at 645 and the process will preferably return to 610 for selection of further content.

If, at 610, it is determined that no virtual tables are available that are associated with players at the physical venue, the system 100 may, at 650, instruct the COD to display advertising content or present an “attract” mode with pre-rendered or simulated game play.

It is to be understood that the checks for advertising breaks and checks for removal of the table may be performed in any order and repeatedly, or may be handled, for instance, using interrupt techniques instead of polling.

For a poker game the COD may be directed to cause display of nameplates for each of the players at the spotlighted virtual table, backs of hidden cards, and the community cards. For a car racing game, the COD may display an overhead view of the track or rotate through individual drivers' views. Generally, the COD may be directed to display views of the multiplayer game comprising a POV showing cards, cars, avatars, or other representations, of all players at the virtual table. While the invention may be described with regard to a player's view or point-of-view (POV), it is to be understood that these terms are meant to refer generally to views comprising textual, visual, or aural information relevant to a player, and not necessarily a first-person view of a virtual environment.

In some embodiments, the transition between POVs may be made responsive to an in-game event, such as a change in highest score, a change in relative position amongst the players, or a negative event occurring for spotlighted player.

If the last person playing the game at a particular venue leaves the game, or the game otherwise ends, the COD may be instructed by the server to enter an “attract mode,” showing a game with virtual players.

It is to be understood that while the present example describes players being organized into virtual tables, players may also be organized on virtual fields, tracks, boards, or other playing locations. The spotlighting approach may also be applied to multiplayer games where each player performs independently, conceptually as each player being at a one-person table.

The multiplayer games may use a variety of architectures, such as synchronous peer-to-peer or client-server. In a preferred embodiment, a client-server architecture is used. Game server 106 preferably processes user input from multiple clients, coordinates the game, and sends results to clients for rendering of the player views. Thus, while multiple game clients may be co-located at a venue with one or more CODs, in a preferred embodiment, those devices do not engage in any direct peer-to-peer communication regarding the game. Instead, each device communicates with game server 106.

In a preferred embodiment, game client and COD platforms may be heterogenous, either executing cross-platform game code or platform-specific game code designed to process a common network communication protocol. In a preferred embodiment, each client receives information from the server sufficient to render the “world” from a player's perspective.

In a preferred embodiment, information is passed from client to server and server to client via messages. In a preferred embodiment, the messages comprise a message name and a sequence of object name-data pairs. Messages may be text strings, preferably transmitted in a compressed and/or encrypted form. In a preferred embodiment, a colon separator is used between the message name and object list, each object name-data pair is enclosed by curly brackets, and data values of the object are delimited by vertical bars or carats.

The mobile device application may send a message such as RequestJoinTable to a matchmaking service. The matchmaking service may respond to the mobile device application with a PlayerJoinTable message comprising identifiers of the table and server the mobile device application should join. The mobile device application may send messages to the server such as PlayerJoinTable and NetworkReceivePlayerBet. In a preferred embodiment of a multiplayer poker game, the server may send messages to clients such as TableBlindStatus, TableDealStatus, TableStatus, and TableResults.

Table Allocation

A matchmaking service may be implemented to control assignment of players to tables. One goal of the matchmaking service may be to keep patrons at a common venue to the fewest number of tables possible, at least in part to improve the ability to display relevant games on the venue COD and display. Another goal of the service may be to combine human players from multiple venues when insufficient players are available at a single venue, but to leave room for the addition of more players from one of those venues who may join at a later time.

In a preferred embodiment, each virtual table may have up to eight players spread over up to four different locations. A minimum table size of four players may be established using virtual artificial intelligence (AI) players. That is, a first player would be placed at a table with three AI players. When a second player joins, one of the AI players is removed and replaced with the new human player. In a preferred embodiment, after four players have been assigned to a table, no AI players are used and only real players, possibly from another venue, are allowed to join the table.

When a new player joins, the system 100 may then first look for a table with other people at same venue as the new player, and if such a table does not exist, assign the new player to a best available table with one or more players at one or more other venues. In a preferred embodiment, the best available table is defined as a table with the fewest human players.

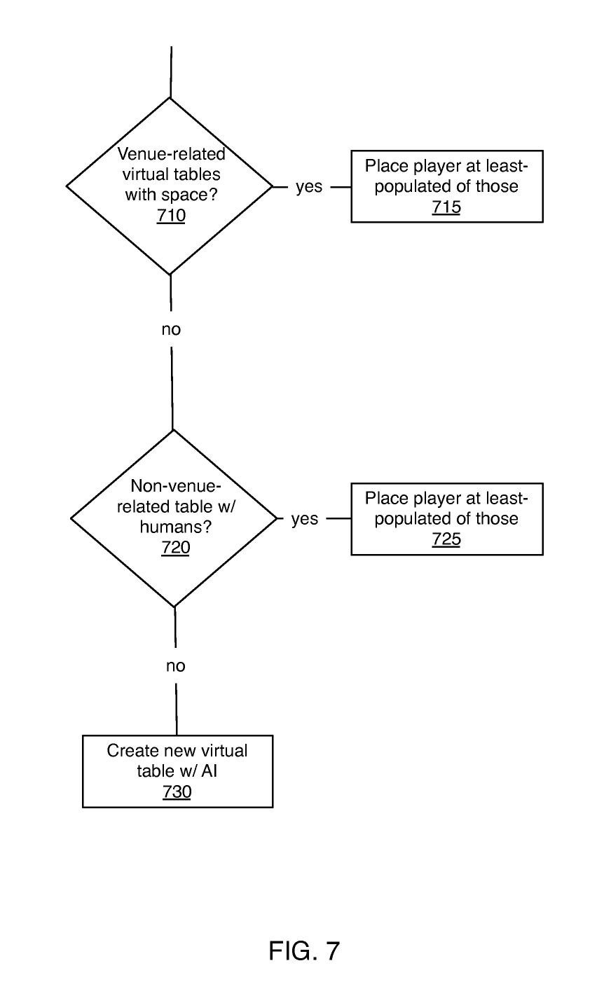

FIG. 7 is a flowchart of an exemplary process of the system of FIG. 1 for assigning a new player to a virtual table. At 710, a determination is made as to whether virtual tables exist at which players at the new player's venue are already playing and at which open seats are available. In some embodiments, virtual players may be occupying seats at a table, which for the purposes of assigning a new human player, may be considered available. If one or more virtual tables with local players and available seats are located, the new player will preferably be associated with the one of those tables with the smallest number of human players.

If, at 710, it is determined that there are no virtual tables with local players and available seats, a determination is made at 720 as to whether there are virtual tables with human players at other venues with available seats. If so, the new player is placed at one of the virtual tables with human players at other venues with the smallest number of human players. In a preferred embodiment, a virtual table with players from other venues will be considered unavailable to a player at an additional venue if the number of venues already represented is at a threshold, such as four.

If, at 720, it is determined that there are no virtual tables with human players at other venues with available seats, a new virtual table will be created at 730 to accommodate the new player. The game system 100 will use virtual opponents at the new virtual table to facilitate game play for the new player. Over time, the virtual players may subsequently be replaced by human players from the same or other venues.

In a preferred embodiment, players are removed from the game after a period of inaction, which may be measured by a number of hands or an amount of time.

If a departing or removed player was the last player at that table at that venue, the table is removed from the COD spotlight rotation for that venue. Another table with local players is spotlighted, preferably when the other table reaches a deal state. Until then, the COD may display a message indicating that the spotlighting of a new table will begin shortly.

While the goal is to assign players at the same venue to the same table, depending upon the order in which players join, a second player at a first venue may not be assigned to the same table as the first player. For instance, even if a player at the venue is the first to join, if a player at a second venue initiates play, that player may be placed at the same table as the player at the first venue to provide each with at least one human opponent. Additional players at the second venue then may possibly fill all of the remaining seats at that table, leaving none available for a second player at the first venue. In that case, the second player at the first venue would be assigned to a second table, and spotlighting would rotate between those two tables.

Photo Comparison Game

Among the multiplayer games that may be facilitated by the described architecture is a multiplayer photo comparison game. In traditional photo comparison games, a single screen is used to display an image and a variant of the image comprising one or more differences. Players identify the differences in the images, in some cases by touching the location of the differences on a touch screen.

Traditional photo comparison games are limited by the number of devices or kiosks made available for play. Furthermore, since the screen is generally visible only to the player, there is a lack of social engagement in the game. Additionally, side-by-side photo comparison games are susceptible to revelation of image difference through cross-eyed viewing similar to that used for viewing of 3D stereograms. It is therefore desirable to have a photo comparison game that is not limited by a number of installed devices, that allows multiplayer gaming and social interaction, and that is not susceptible to cheating. To provide these and other benefits, a system for a new multiplayer photo comparison game is described.

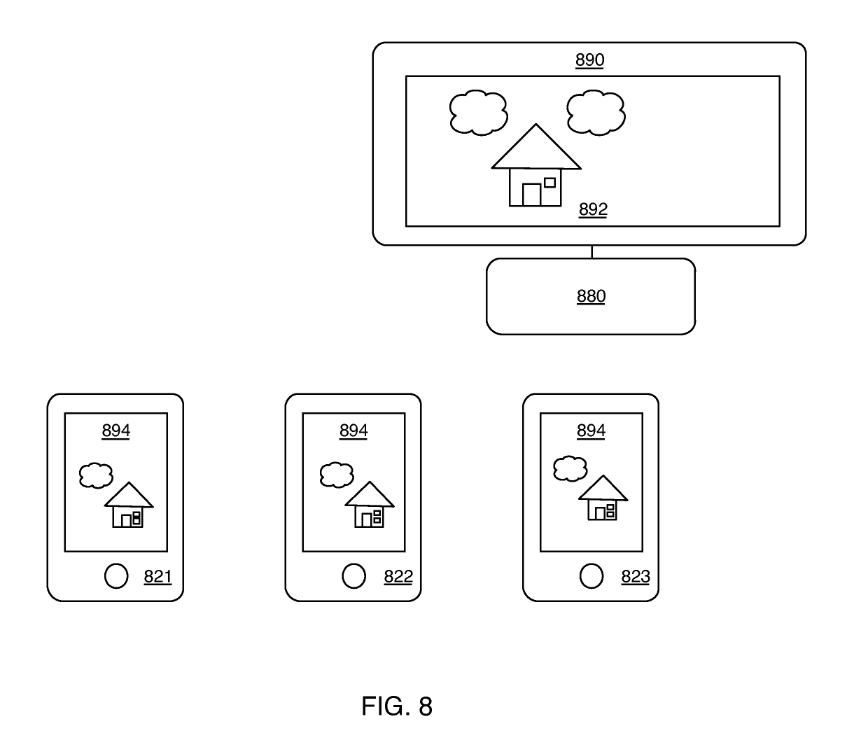

FIG. 8 is an illustration of a multiplayer photo comparison game. Upon registration of a mobile device 821, 822, or 823 with a venue, the photo comparison game may be presented as an option by COD 880 and display 890. Upon initiation of a photo comparison game, the COD 880 may be instructed to display one of the images 892 to be compared. The other image 894 may be sent to the mobile device application on devices 821, 822, and 823 for display. In a preferred embodiment, the player touches a touch screen of the mobile device to select areas where the photos differ.

In a preferred embodiment, the same comparison image 894 may be sent to each mobile device application playing the photo comparison game. In alternative embodiments, different images with different variations on image 892 may be sent to different mobile devices.

In one embodiment, upon a first player using mobile device 821 selecting one of the differences, the COD 880 may highlight the position of the difference or otherwise indicate the difference through manipulation of the displayed image 892. The highlighting or manipulation may be accompanied by an identifier of the player who first identified the difference. In another embodiment, difference may not be shown on image 892 until either all players have identified all difference or until a timer has expired. In a preferred embodiment, decreasing numbers of points are awarded to players as the time needed to identify the differences in the images increases.

The spotlighting techniques described above may be applied to the multiplayer image comparison game. In a preferred embodiment, when a particular game is not being spotlighted, either because another game is being spotlighted or because of an advertising break, both the original and comparison image may be displayed on mobile devices 821, 822, and 823, during the break in spotlighting of the game.

In a preferred embodiment, COD 880 renders image 892 based, at least in part, upon information received from a game server associated with the multiplayer image comparison game. Similarly, mobile device applications on devices 821, 822, and 823 preferably communicate with the game server, as described in the examples above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of associating a mobile application on a mobile device with a multiplayer game comprising:
receiving, at a server system, location information related to a mobile device;
comparing, at the server system, the location information related to the mobile device to a plurality of location entries corresponding to a plurality of venues;
determining a subset of the plurality of venues based upon distance between a location determined from the location information related to the mobile device and locations related to each of the plurality of venues; and
sending, from the server system to the mobile device, venue information comprising at least two of: an identifier, descriptive information, and location information, for each venue of the subset of the plurality of venues.

2. The method of claim 1, further comprising:
sending an indication of user selection of a user interface element related to presentation of venue information for one venue of the subset of the plurality of venues.

3. The method of claim 1, further comprising:
determining, at the server system, information related to a list of available games associated with the selected venue;
sending, from the server system to the mobile device, information related to the list of available games associated with the selected venue;
presenting, at the mobile device, a representation of the list of games;
receiving, at the mobile device, an indication of selection by a user of a user interface element related to one game from the list of available games; and
sending, from the mobile device to the server system, the identifier related to the selected game.

4. The method of claim 1, further comprising:
receiving, at the mobile application, credential information;
sending the credential information to a server system; and
validating the credentials at the server system.

5. A method of determining a set of virtual tables of a multiplayer game to be spotlighted at a venue, comprising:
determining a venue associated with a player to be added to a multiplayer game;
determining a virtual table to which the player will be added;
determining whether the determined virtual table is already associated with a list of virtual tables to be spotlighted at the venue;
responsive to a determination that the selected virtual table is not already associated with a list of virtual tables to be spotlighted at the venue, adding the selected virtual table to the list of virtual tables to be spotlighted at the venue.

6. The method of claim 5, wherein determining a venue comprises determining an identifier associated with a physical venue.

7. The method of claim 5, wherein determining whether the determined virtual table is already associated with a list of virtual tables to be spotlighted at the venue comprises determining whether another player already associated with the virtual table is associated with the venue.

8. A method of determining a set of virtual tables of a multiplayer game to be spotlighted at a venue, comprising:
determining a venue associated with a player leaving a multiplayer game;
determining the virtual table from which the player is leaving;
determining whether additional players associated with the determined venue are associated with the determined virtual table; and
responsive to a determination that no additional players associated with the determined venue are associated with the determined virtual table, removing the determined virtual table from a list of virtual tables to be spotlighted at the determined venue.

9. The method of claim 8, wherein determining a venue comprises determining an identifier associated with a physical venue.

10. A method for public presentation of a multiplayer game in a venue, comprising:
determining whether there is at least one virtual table of the multiplayer game comprising players associated with the venue; and
responsive to a determination that there is at least one virtual table comprising players associated with the venue:
transmitting game information regarding at least one of the at least one virtual table of the multiplayer game to a content output device at the venue; and
rendering, by the content output device at the venue, a view of the multiplayer game using the transmitted game information regarding the at least one of the at least one virtual table of the multiplayer game.

11. A method for selecting a virtual table for a player of a multiplayer game, comprising:
receiving an indication of a venue associated with the player;
determining for a plurality of virtual tables whether any of the virtual tables comprise at least one other player associated with the venue and has at least one available seat; and
responsive to a determination that at least one of the plurality of virtual tables comprises at least one other player associated with the venue, associating the player with one of the at least one of the plurality of virtual tables with the smallest number of other players.

12. The method of claim 11 further comprising:
responsive to a determination that none of the plurality of virtual tables comprises at least one other player associated with the venue,
determining for the plurality of virtual tables whether any of the virtual tables without other players associated with the venue has at least one available seats; and
responsive to a determination that at least one of the virtual tables of the virtual tables without other players associated with the venue has at least one available seats, associating the player with one of the at least one of the plurality of virtual tables without other players associated with the venue with the smallest number of other players.

13. The method of claim 11 further comprising:
responsive to a determination that none of the plurality of virtual tables has an available seat:
creating a new virtual table; and
associating the player with the new virtual table.

14. The method of claim 10 wherein determining whether there are virtual tables of the multiplayer game comprising players associated with the venue comprises one of checking location IDs associated with users or checking a list of location IDs associated with the virtual table.

15. The method of claim 10 wherein rendering, by the content output device at the venue, a view of the multiplayer game comprises rendering a POV comprising avatars of all players.

16. The method of claim 10 wherein information regarding the multiplayer game is information for use in rendering a POV of the multiplayer game comprising information regarding each of the plurality of players of the multiplayer game.

17. A method for providing a multiplayer image comparison game, comprising:
storing information regarding the locations of difference between a first image and a second image;
sending data to cause presentation of the first image on a display at a venue;
sending data to facilitate rendering the second image to a plurality of mobile devices associated with the venue and executing a mobile application for playing the multiplayer image comparison game;
receiving information from the plurality of mobile devices associated with the venue related to user input to the mobile application for playing the multiplayer image comparison game.

18. The method of claim 17 wherein the first image is a photograph and the second image is a modified version of the photograph.

19. The method of claim 17 wherein the user input is generated responsive to a player touching a touch screen of a mobile device to select areas where the photos differ.

20. The method of claim 17 wherein data to facilitate rendering of a third image is sent to a second plurality of mobile devices.
